(19) United States
(12) Patent Application Publication
(10) Pub. No.: US 2011/0276554 A1
(43) Pub. Date: Nov. 10, 2011

(54) Query and note based search system

(76) Inventor: Chen-Yu Sheu, Irvine, CA (US)

(21) Appl. No.: 12/800,125

(22) Filed: May 10, 2010

(51) Int. Cl. G06F 17/30; G06F 3/048

(52) U.S. Cl. 707/706; 715/764; 707/E17.108; 707/E17.015

(57) ABSTRACT

This invention provides a query and note based content creation, sharing and search system that allows users to create and manage notes, to share the notes with others, and to query the notes from a cellphone or computer interface. This is different from the traditional Internet and search engines in which user queries can only be indirectly answered. This invention allows users to query the notes from a cellphone or a computer when a prompt and precise response is needed. This invention also allows one or more programs to be specified for a note so when the note is returned to the user the program(s) can be executed.

### BACKGROUND OF THE INVENTION

1. Field of the Invention

This invention is related to a query and note based content creation, sharing and search system (QNSS) that allows users to create and describe notes, to share the notes with others, and to search the notes based on their content from a cellphone or computer interface.

2. Description of the Related Art

The Internet has provided a global infrastructure to connect content from different websites. Traditional search engines have done an excellent job for searching the web pages. However it has been difficult, if not impossible, for a search engine to reach the “objects” inside of a web page. As a consequence, a search engine usually cannot directly answer a query; rather it returns a set of possible web pages whose content may answer the query. This makes it difficult for users to query the content from a cellphone or a computer when a prompt and precise response is needed.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

This invention provides a query and note based content creation, sharing and search system that allows users to create and manage notes, to share the notes with others, and to query the notes based on their content from a cellphone or computer interface. This is different from the traditional Internet and search engines in which user queries can only be indirectly answered.

The invention is different from existing blog systems because:
(1) A blog system usually does not have access control, i.e., all notes in a blog system are open to the public.
(2) Each note in this invention is annotated by one or more queries to support a search engine for precise search based on notes.
(3) In this invention one or more programs can be associated with a note so they can be executed if the note is matched to a query.
   The invention is also different from existing social network systems such as Facebook or Twitter because it is designed to be a search system not a content distribution system.

### BRIEF DESCRIPTION OF THE DRAWINGS

FIG. 1 illustrates one embodiment of the query and note based content creation, sharing and search system

FIG. 2 illustrates one embodiment of the note composition process

FIG. 3 illustrates one embodiment of the control flow of the search process

### DETAILED DESCRIPTION OF THE PREFERRED EMBODIMENT

The following subsections describe a query and note based content creation, sharing and search system that embodies various inventive features. The various inventive features can be implemented differently than described herein. Thus, the following description is intended only to illustrate, and not limit, the scope of the present invention.

### Architecture of NISS

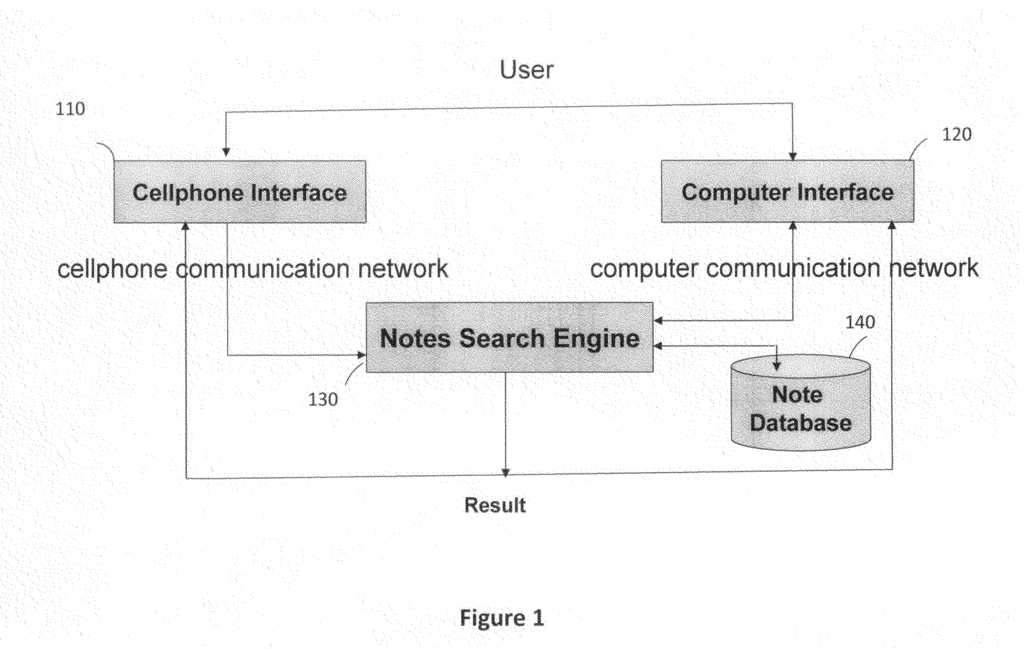

FIG. 1 illustrates one embodiment of a Query and Note based content creation, sharing and Search System (QNSS). The cell phone 110 could be any ordinary cellphone that can be connected to the search engine 130 using a cellphone communication network (such as GPRS, CDMA). The computer 120 could be any ordinary computer that can be connected to the control software via using a computer communication network (such as HTTP, WiFi). In either case, with a standard cellphone interface or browser interface, a user can compose a query sentence and send it to the note search engine 130, and a user can create a note and send it to the notes search engine 130. The note database 140 stores all notes created by the user. It consists of Private Notes, Controlled Notes, and Public Notes. The notes search engine matches a query with the notes and returns those who can match the query via a communication network.

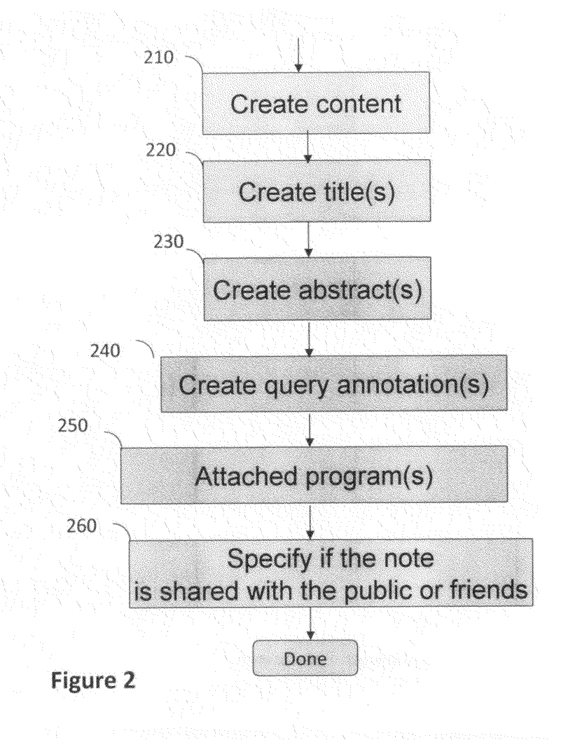

FIG. 2 shows one embodiment of a computer-implemented process of composing a note. It is required a note has to have content, which is typically expressed in text and hyperlinks at a block 210. If the user wants to define any title, the process proceeds to a block 220, where the user specifies one or more titles. If the user wants to define an abstract, the process proceeds to a block 230, where the user specifies one or more abstracts. At a block 240, the process asks the user to specify one or more queries. At a block 250, the process asks the user to specify one or more programs which may be executed when the note is matched by a query. By default a note is private to the user. If the user wants to share the note with the public or make the note a controlled note (to be shared with friends), she/he can do so at a block 260.

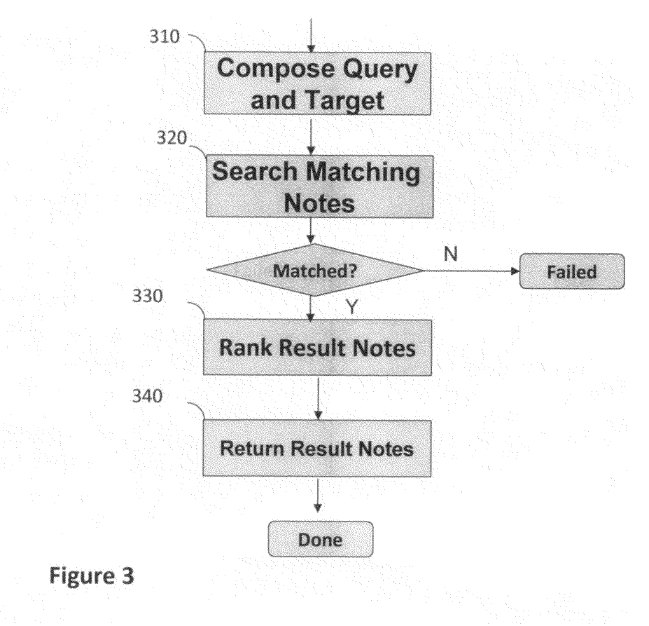

FIG. 3 shows one embodiment of a computer-implemented process of querying the notes. At a block 310, the user specifies the target of the query, which may be the public notes, private notes or the (public or controlled) notes of another user, and a query which may be one or more keywords, a natural language sentence, or a sentence in structured natural language expressed in the form of

Verb Noun [Adjectives]

where the adjectives are optional.

If the target of the query is the controlled notes of another user, the user may need to provide an access code or be authenticated as a friend. The query is matched against the notes in the corresponding database in a block 320. All matched notes are ranked in a block 330 and the content of the result notes are returned to the user at a block 340. If there are programs specified for a result note, the programs are executed when the note is returned.

The system may have a variation that at block 340 only the content of the note with the top rank is returned; and if the note has some programs specified the programs are executed. The system may have another variation that only the URLs of the result notes are returned and a user can choose from the list some notes to read; and if a note chosen has some programs specified the programs are executed when the note is read.

What is claimed is:

1. A query and note based content creation, sharing and search system, the system comprising
a computer or cellphone interface that can be connected to a server using a communication network and that allows a user to compose query sentences remotely;
a computer interface or cellphone interface that can be connected to a server using a communication network and that allows the user to compose a note;
a note database that stores all the notes created by users;
a computer search engine that searches the notes based on a query and a target specified by the user.

2. The system of claim 1, further comprising that each note has a unique URL (Uniform Resource Locator) that may be the URL of the system concatenated with the address of the note in the database or a query that may locate the note in the database.

3. The system of claim 1, further comprising that the content of a note is text.

4. The system of claim 1, further comprising that the content of a note contains one or more hyperlinks that once clicked will go to another URL.

5. The system of claim 1, further comprising that a note has one or more titles.

6. The system of claim 1, further comprising that a note has one or more abstracts.

7. The system of claim 1, further comprising that a note has one or more queries which may be a set of keywords, a natural language sentence, or a sentence in structured natural language.

8. The system of claim 1, further comprising that a note contains one or more attached programs.

9. The system of claim 1, further comprising that a note can be a private note, a public note (a note of a user that is decided by the user to be shared with the public), or a controlled note (a note of a user that is decided by the user to be shared with friends).

10. A computer-implemented method of composing a note, the method comprising:
a user uses a cellphone or computer interface to specify the content of the note;
prompting a user to specify if the note is to be shared with the public (a public note), shared with friends (a controlled note), or private to himself.

11. The method of claim 10, further comprising that a user can create one or more titles for the note.

12. The method of claim 10, further comprising that a user can create one or more abstracts for the note.

13. The method of claim 10, further comprising that a user can specify one or more programs for the note.

14. The method of claim 10, further comprising that a user can create one or more queries for the note that may consist of one or more keywords, a natural language sentence, or a sentence in structured natural language.

15. The method of claim 10, further comprising that a user can create an access code for a controlled note.

16. A computer-implemented method of searching a note, the method comprising:
a user uses a cellphone or computer interface to specify the target of a query, which may be public, the user himself, another user or a group of users, and a query which may consist of one or more keywords, a natural language sentence, or a sentence in structured natural language;
a user sends the query and its target to the search engine using a communication network;
the search engine matches the query with the notes of the specified target in the database;
the search engine ranks the notes found;
the search engine returns the content of the ranked notes.

17. The method of claim 16, further comprising prompting a user to enter an access code to search for a controlled note.

18. The method of claim 16, further comprising that if a note in the result has one or more programs specified, the program(s) are executed when the note is returned to the user.

19. The method of claim 16, further comprising that the search engine returns the list of URLs of the notes found so a user can choose a subset of the result for further reading.

20. The method of claim 19, further comprising that if a note in the result has one or more programs specified, the program(s) are executed when the note is chosen by a user for further reading.
